(19) United States
(12) Patent Application Publication
(10) Pub. No.: US 2025/0020888 A1
(43) Pub. Date: Jan. 16, 2025

(54) OPTICAL COMPONENT HAVING A TEMPERATURE DEPENDENT FOCAL LENGTH

(71) Applicant: Optotune Switzerland AG, Dietikon (CH)

(72) Inventors: Manuel Aschwanden, Allenwinden (CH); Michael Büeler, Vogelsang (CH); Jonathan Hobbis, Kilchberg (CH)

(73) Assignee: Optotune Switzerland AG, Dietikon (CH)

(21) Appl. No.: 18/768,055

(22) Filed: Jul. 10, 2024

(30) Foreign Application Priority Data
Jul. 13, 2023 (DE) 10 2023 118 656.6

(51) Int. Cl. G02B 7/02; G02B 3/14

(52) U.S. Cl. CPC G02B 7/028; G02B 3/14

(57) ABSTRACT

Optical component (8) having a temperature dependent focal length comprising:
a first rigid optical element (9) with a first interface (10); a second rigid optical element (11) with a second interface (12); a third optical element (13) comprising a third material, wherein the third optical element (13) is arranged between the first rigid optical element (9) and the second rigid optical element (11) such that the first interface (10) and the second interface (12) each face the third optical element (13);
the third optical element (13) having a larger temperature coefficient of index of refraction than first rigid optical element (9) or the second rigid optical element (11);
the first interface (10) and/or the second interface (12) being non-flat and configured to change an optical refraction power of the first interface (10) or to change an optical refraction power of the second interface (12) with changing temperature, wherein this change corresponds to the temperature dependent focal length of the optical component (8).

### CROSS-REFERENCE TO RELATED APPLICATIONS

This application claims the right of priority to German Patent Application No. DE 10 2023 118 656.6, filed on Jul. 13, 2023, the contents of which are incorporated by reference in its entirety.

### FIELD

The invention relates to an optical component having a temperature dependent focal length.

### BACKGROUND

Optical components play crucial roles in different applications, especially in cameras, enabling the capture, manipulation, and transmission of light to produce high-quality images.

Optical components can be designed as lenses as a part of a lens system. They gather and focus light onto the image sensor, controlling factors such as focus, zoom, depth of field, and image quality.

Typically, lens systems have a temperature-dependent focal length, which relates to a change of focal length as a function of the ambient temperature. It is a characteristic that arises due to the thermal expansion or contraction of the lens materials with temperature changes.

When the lens system is subjected to temperature variations, the physical dimensions of the lens elements can change, causing a shift in the effective focal length. As the temperature increases, the lens materials expand, resulting in a longer focal length, while a decrease in temperature can lead to a shorter focal length.

The temperature dependence of the focal length can have practical implications in imaging systems, especially those requiring high precision or stability. It is therefore advantageous to implement temperature compensation mechanisms to mitigate the impact of temperature changes on the focal length, especially in lens systems.

### SUMMARY

It is an objective of the invention to propose an optical component with which thermal drift can be compensated.

The objective is solved by means of an optical component according to claim 1. Preferred embodiments are subject matters of dependent claims 2 to 25.

### BRIEF DESCRIPTION OF THE FIGURES

Further advantages of the invention are described with respect to the Figures and the embodiments shown therein.

FIGS. 1A-1C a lens system without temperature drift compensation in three different temperatures in views FIG. 1A), FIG. 1B), FIG. 1C);

FIG. 2 shows a first embodiment of an optical component having a temperature dependent focal length;

FIG. 3 shows a second embodiment of an optical component having a temperature dependent focal length;

FIG. 4 shows a third embodiment of an optical component having a temperature dependent focal length;

FIG. 5 shows a fourth embodiment of an optical component having a temperature dependent focal length;

FIG. 6 the lens system with an optical component according to FIG. 3.

### DETAILED DESCRIPTION

According to the invention, the optical component has a temperature dependent focal length and comprises a first rigid optical element, a second rigid optical element and a third optical element. The first rigid optical element comprises a first material and a first interface. The second rigid optical element comprises a second material and a second interface. The third optical element comprises a third material and is arranged between the first rigid optical element and the second rigid optical element such that the first interface and the second interface each face the third optical element. The third optical element has a larger temperature coefficient of index of refraction than first material or the second material. Moreover, the first interface or the second interface is non-flat and configured to change an optical refraction power of the first interface or to change an optical refraction power of the second interface with changing temperature, wherein this change corresponds to the temperature dependent focal length of the optical element.

The optical component is in particular designed to address the temperature-dependent focal length issues encountered in lens systems. By incorporating a specific arrangement of materials and interfaces, the optical component achieves a controlled variation of refraction power with changing temperatures, thus enabling a predictable temperature-dependent focal length.

The optical component consists of three main elements: a first rigid optical element, a second rigid optical element, and a third optical element. The first rigid optical element comprises a first material and a first interface, while the second rigid optical element comprises a second material and a second interface. Positioned between these two rigid elements, the third optical element is composed of a third material. Importantly, the third material possesses a higher temperature coefficient of the index of refraction compared to the first and second materials.

The first and second interfaces, at least one of which is designed as a non-flat surface, play a crucial role in achieving the desired temperature-dependent behavior of the optical component. With changing temperature, these non-flat interfaces induce variations in the optical refraction power, which correspond to the desired focal length adjustments. By precisely controlling the design of these non-flat interfaces, the optical component can compensate for temperature-induced changes, resulting in a change of focal length of the optical component.

The term “temperature coefficient of index of refraction” may be understood as a change of the index of refraction as a function of the temperature.

According to the invention the focal length may be considered as a property of the optical component that determines the degree of convergence or divergence of light rays passing through the optical component. It is defined as the distance between the lens and its focal point. In simple terms, the focal length represents the distance from the lens at which incoming parallel rays of light converge or appear to converge after passing through the lens. It is typically measured from the optical center of the lens to the focal point.

The optical component provides a novel approach to address the temperature dependence of the focal length in optical components. By combining specific materials, non-flat interfaces, and the differential thermal properties of the third optical element, the component achieves a temperature-dependent focal length that can be reliably calibrated and utilized in various applications requiring stable optical performance under changing environmental conditions.

The optical component in particular provides benefits in industries relying on optics or precise imaging systems, such as scientific instrumentation, industrial metrology or photography.

Preferably, the optical component has an optical axis along which the first rigid optical element, the second rigid optical element and the third optical element are arranged.

Preferably, the first rigid optical element, the second rigid optical element and the third optical element each are transparent or at least each have an optical area that is arranged along the optical axis and is transparent.

It is within the scope of the invention that the optical component is a part of a lens system comprising at least one lens, preferably more than one lenses.

In a preferred embodiment, the optical component comprises a flexible element, which mechanically connects the first rigid optical element with the second rigid optical element and is configured to absorb a thermal expansion of the third optical element.

The purpose of incorporating a flexible element within the optical component is to provide a mechanism that can compensate for temperature-induced changes in the dimensions of the third optical element. As the temperature changes, the third optical element may undergo thermal expansion, causing its size to increase. This expansion can potentially introduce strain or stress within the lens system, which may affect the optical performance or structural integrity.

To address this issue, the preferred embodiment employs a flexible element that can accommodate the thermal expansion of the third optical element without transferring stress or strain to the other rigid optical elements. The flexible element acts as a buffer or connector, allowing the third optical element to expand or contract freely with changing temperature, while maintaining the mechanical stability and integrity of the lens system.

The flexible element may be made of materials with high elasticity or flexibility, such as certain polymers or elastomers. These materials can undergo deformation without permanent damage and return to their original shape after the temperature changes. By connecting the first and second rigid optical elements through this flexible element, the lens system can effectively absorb the thermal expansion of the third optical element, ensuring that it does not negatively impact the overall optical performance.

Overall, the inclusion of a flexible element in the optical component's design offers a practical solution to mitigate the potential effects of thermal expansion. By accommodating the thermal changes within the lens system, the flexible element helps maintain the optical performance, stability, and durability of the component, providing a reliable and efficient solution for applications requiring precise and stable optical performance in varying temperature conditions.

In a preferred embodiment, the first interface is inflection point free in its optical area.

The term “inflection point” refers to a point on a curve where the curvature changes sign. In the context of the first interface of the optical component, being inflection point free means that the curvature of the surface remains consistent and does not exhibit any abrupt changes or reversals within the region responsible for manipulating light.

By ensuring that the first interface is inflection point free in its optical area, the preferred embodiment aims to achieve smoother and more predictable optical behavior. This characteristic is particularly important in maintaining the optical quality and performance of the lens system.

Having a smooth and continuous curvature on the first interface helps to minimize distortions, aberrations, and unwanted light scattering that can occur when the surface exhibits irregularities or abrupt changes in curvature. It allows for better control and manipulation of the light passing through the interface, resulting in improved image quality, reduced aberrations, and enhanced overall optical performance.

By carefully designing the first interface to be inflection point free within its optical area, the preferred embodiment ensures that the light rays passing through this region experience a consistent and controlled refraction. This contributes to more accurate focusing, sharper imaging, and better alignment of the light rays within the lens system.

In summary, the preferred embodiment focuses on creating an optical component with a first interface that is inflection point free within its optical area. This design choice aims to enhance the optical performance by minimizing distortions, aberrations, and scattering effects, resulting in improved image quality and overall system performance.

In a preferred embodiment, the absolute value of the focal length change is larger than 1 diopter.

The focal length of a lens determines the degree of convergence or divergence of light rays passing through it. In this embodiment, the optical component is specifically designed to have a substantial variation in its focal length, exceeding 1 diopter.

A diopter is a unit of measurement used to quantify the optical power of a lens. A lens with a focal length of 1 meter (1000 mm) has an optical power of 1 diopter. Therefore, a focal length change larger than 1 diopter indicates a substantial alteration in the optical power of the lens component.

The significant change in focal length provided by this preferred embodiment allows for versatile and adaptable optical characteristics. Such a lens system can accommodate a wide range of imaging requirements, including the ability to focus on objects at various distances, adjust depth of field, or accommodate different magnification levels.

By offering a focal length change larger than 1 diopter, the optical component in this embodiment enables precise control and manipulation of light, providing flexibility in capturing images and achieving desired optical effects. This characteristic makes the component well-suited for applications requiring adjustable focal lengths and dynamic optical performance.

In a preferred embodiment, a radius of the first interface or a radius of the second interface is smaller than 1 meter. In particular, the radius of the first interface or the radius of the second interface is smaller than 100 millimeters and preferably smaller than 10 millimeters.

In a preferred embodiment, wherein the third optical element is a fluid, a liquid or a gel.

In this embodiment, the third optical element within the optical component is designed to be a liquid or a gel material. This choice of material offers specific advantages and characteristics that contribute to the overall functionality and performance of the optical component.

By utilizing a liquid or gel as the third optical element, the embodiment enables properties such as tunability, adaptability, and variable refractive indices. Liquids and gels can exhibit refractive index variations by manipulating their composition, temperature, or external factors, providing opportunities for dynamic optical adjustments.

The use of a liquid or gel allows for easy modulation of the optical properties of the component. The refractive index of the third optical element can be precisely controlled by changing the composition or temperature of the liquid or gel, thereby enabling fine-tuning of the optical performance and focal length of the lens system.

Additionally, liquids and gels are often characterized by their fluidity and ability to conform to different shapes and surfaces. This flexibility can facilitate the integration and alignment of the third optical element within the overall lens system, ensuring optimal optical performance and minimizing potential aberrations or distortions.

The choice of a liquid or gel as the third optical element in this preferred embodiment also offers advantages in terms of thermal expansion compensation. Liquids and gels can exhibit relatively low thermal expansion coefficients, which can help mitigate the impact of temperature changes on the lens system's focal length and maintain stability in various environmental conditions.

In another preferred embodiment, the third optical element is a polymer.

In this embodiment, the third optical element within the optical component is specifically chosen to be a polymer material. The use of a polymer as the third optical element offers distinct advantages and characteristics that contribute to the overall functionality and performance of the component.

Polymers are versatile materials known for their optical transparency, mechanical flexibility, and ease of fabrication. By utilizing a polymer as the third optical element, the embodiment benefits from these properties to achieve specific optical effects and functionalities.

The choice of a polymer as the third optical element enables precise control over its composition, allowing for the customization of refractive index, optical dispersion, and other optical properties. This flexibility in material design allows for tailoring the optical performance of the component to meet specific requirements.

Polymers also offer advantages in terms of lightweight construction and ease of integration. Their relatively low density makes them suitable for reducing the overall weight of the optical component, which can be advantageous in applications where weight is a critical factor, such as in portable or handheld devices.

Additionally, polymers can exhibit low thermal expansion coefficients, aiding in the stability of the optical system under varying temperature conditions. This characteristic helps mitigate the impact of temperature changes on the focal length and optical performance, ensuring consistent and reliable operation.

In a preferred embodiment, the third optical element and the flexible element are embodied in a one-piece manner.

According to the embodiment described above, the term “one-piece” manner relates to an embodiment in which the third optical element and the flexible element can be integrally connected to each other. It is also within the scope of further development that the third optical element and the flexible element can represent one and the same component, which has different component areas that can be formed as a third optical element or as a flexible element.

It is however possible that the third optical element and the flexible element comprise a polymer or a gel. In a case, where the third optical element comprises a fluid, a liquid or a gas, the third optical element comprises freely bounded molecules.

In a preferred embodiment, the optical element being designed as comprising a compensation value of more 10 milli diopters per Kelvin preferably more than 50 milli diopters per Kelvin.

Preferably, an absolute value of a refractive temperature index change of the third optical element, in particular the fluid, is greater than 8*10\hat{ }-4 1/Kelvin, preferably greater than 5*10\hat{ }-4 1/Kelvin, in particular 1*10\hat{ }-4 1/Kelvin. In particular the ambient temperature rages between −40° C. to 80° C. or −40° C. to 110° C.

In a preferred embodiment, a radius of the first interface comprises a midpoint, which is located towards the third optical element in relation to the first rigid optical element. In other words, the first interface has a concave curvature.

In another possible embodiment, a radius of the first interface comprises a midpoint, which is located in relation to the first rigid optical element away from the third optical element. In other words, the first interface has a convex curvature.

Preferably, the first rigid optical element is designed as a rigid lens, preferably comprising a polymer, a plastic or a glass.

In a preferred embodiment, the second optical element is designed as a flat window or a lens, preferably comprising a polymer, plastic or a glass.

In a preferred embodiment, the flexible element is designed as a membrane and is attached to the first interface and/or the second interface. In particular, the membrane may at least partly define the second interface in case the second optical element is designed as a flat window or a lens. Alternatively, the membrane may be attached to the second optical element in a peripheral area, enclosing the second interface, which is defined by the second optical element. Preferably, the membrane is located between the fluid and the first rigid optical element.

Preferably, the optical component has an optical power, which is substantially 0 diopter at room temperature.

In a preferred embodiment, preferably at least at room temperature, a refractive index of the third optical element and a refractive index of the first or the second material are substantially the same, or the difference in said refractive indexes is smaller than 0.2 diopter or smaller than 0.5 diopter.

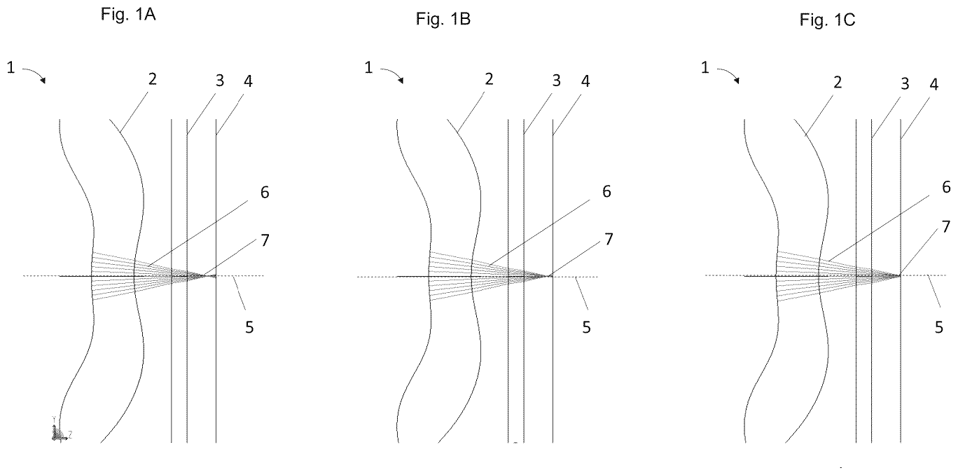

For a better understanding, reference signs as used in FIGS. 1 to 4 are explained below:
1 Lens system
2 Curved lens
3 Planar lens
4 Reference plane
5 Optical axis of the lens system
6 Bundle of rays
7 Focus point
8 Optical component
9 First rigid optical element
10 First optical surface
11 Second rigid optical element
12 Second optical surface
13 Third optical element
14 Membrane
15 Optical axis of the optical component
16 Common surface between flexible element and second rigid optical element

Optical components are vital in various applications, particularly in cameras, as they facilitate the capture, manipulation, and transmission of light for the production of high-quality images.

Lens systems, which are comprised of optical components like lenses, have a focal length that can vary with changes in temperature. This temperature-dependent focal length is influenced by the expansion or contraction of lens materials in response to temperature fluctuations.

Temperature variations affect the physical dimensions of lens elements, causing a shift in the effective focal length. As temperature rises, lens materials expand, resulting in a longer focal length. Conversely, a decrease in temperature leads to a shorter focal length.

The temperature dependence of the focal length has practical implications, especially in imaging systems that require precision and stability. Implementing temperature compensation mechanisms becomes advantageous to mitigate the impact of temperature changes on the focal length, particularly in lens systems.

FIG. 1 illustrates the effect that temperature drift can have on the optical properties of a lens assembly.

FIG. 1 shows in views a), b) and c) one and the same lens system 1, which has a curved lens 2 and a planar lens 3, both of which are arranged in front of a reference plane 4.

Furthermore, the lens system 1 has an optical axis 6 along which the curved lens 2 and the planar lens 3 of the lens system 1 described above are arranged.

According to view a) the lens system 1 is in a working environment with an ambient temperature of −40° C. In view b) the lens system 1 is at an ambient temperature of 20° C. View c) shows the lens system at an ambient temperature of 110° C. Therefore, views a) to c) cover a temperature range of 150° C.

As can be seen from views a), b) and c) of FIG. 1, a bundle of light rays 6 falls into the lens system 1 essentially along the optical axis and is focused at the focal point 7. As can also be seen from views a), b) and c), there is a systematic dependence of the position of the focal point 7 relative to the reference plane 4 as a function of temperature.

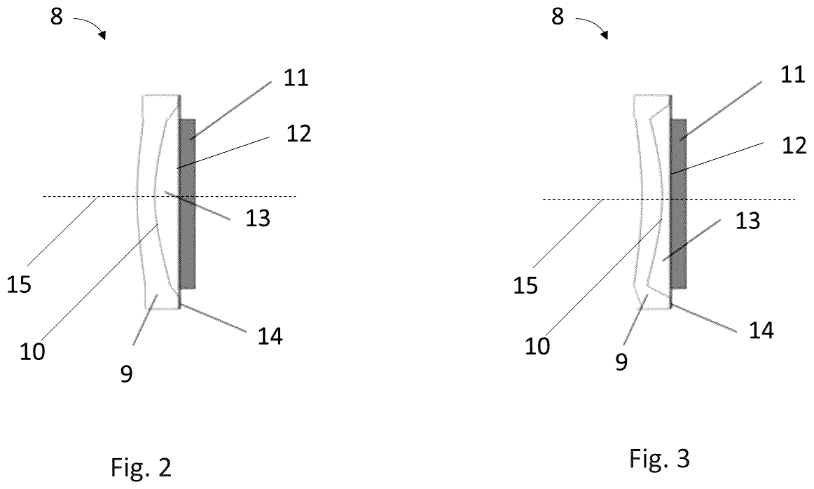

Regardless of the lens system 1 embodiment shown in FIG. 1, the dependence of the focal power on the temperature leads to the temperature drift described above, which can be compensated by means of an optical component as shown in FIGS. 2 and 3.

FIG. 2 shows a second embodiment of an optical component 8 having a temperature dependent focal length and comprises a first rigid optical element 9 made of polymer and which comprises a first interface 10. Moreover, the optical component 8 comprises a second rigid optical element 11 made of glass and which comprises a second interface 12. In general, the first rigid optical element 9 and/or the second rigid optical element 11 may each be made of any transparent material, in particular polymer, plastic or glass.

Furthermore, the optical component 8 comprises a third optical element 13 which is enclosed between the first optical surface 10 and the second optical surface 12. The third optical element 13 has a larger temperature coefficient of index of refraction than the material of the first rigid optical element 9 or the material of the second rigid optical element 11. Moreover, the first interface 10 and the second interface 12 are configured to change an optical refraction power of the first interface 10 or to change an optical refraction power of the second interface 12 with changing temperature, wherein this change corresponds to the temperature dependent focal length of the optical element.

According to FIG. 2, the third material 13 is a transparent liquid.

The design of the optical component 8 enables a compensation value of approximately 50 milli diopters per Kelvin. An absolute value of a refractive temperature index change of the third optical element 13 is greater than 8*10\hat{ }-4 1/Kelvin. At least at room temperature, a refractive index of the third optical element 13 and a refractive index of the first or the second material are substantially the same. Alternatively, the difference in said refractive indexes may be smaller than 0.5 diopter.

Furthermore, the optical component 8 comprises a flexible membrane 14, which is attached to both the first rigid optical element 9 and the second rigid optical element 11.

The optical component 8 shown in FIG. 2 also comprises an optical axis 15, along which the first rigid optical element 9, the second rigid optical element 11 and the third optical element 13 are arranged. The optical axis 15 impinges the optical component 8 through a transparent area.

The optical component 8 is designed to be arranged in a lens system 1 as shown in FIG. 2 such that the optical axis 5 of the lens system 5 essentially coincides with its optical axis 15.

The optical component 8 as shown in FIG. 2 may be considered a negative focus drift compensator due to the concave curvature of the first optical surface 10.

In contrast to the optical component shown in FIG. 2, FIG. 3 shows another optical component 8, which essentially has the same design as the optical component as shown in FIG. 2, however may be considered a positive drift compensator due to the convex curvature of the first optical surface 10. Beyond that, the explanations regarding FIG. 2 can be applied accordingly.

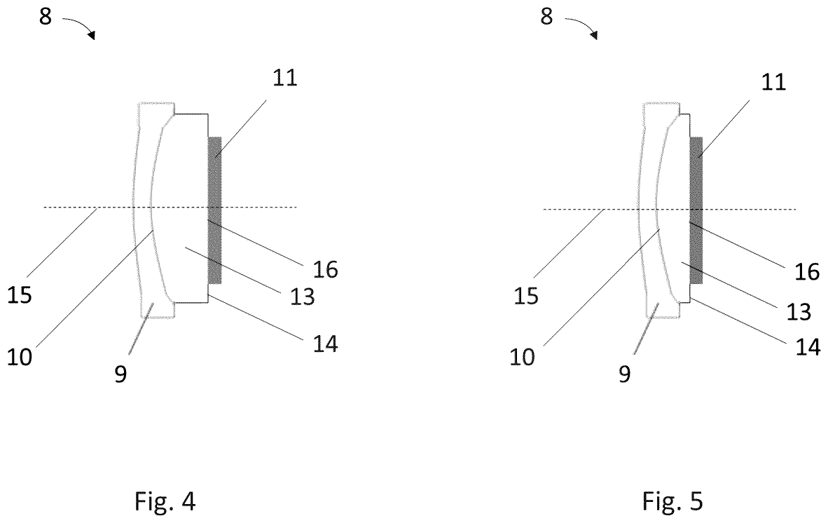

FIG. 4 shows a third embodiment of an optical component 8 having a temperature dependent focal length. The optical component 8 according to FIG. 4 comprises a first rigid optical element 9 made of polymer, which has a first interface 10. A second rigid optical element 11 is made of polymer and comprises a second interface 12. Moreover, the optical component 8 comprises a third optical element 13, which is enclosed between the first optical surface 10 and the second optical surface 12 and has a larger temperature coefficient of index of refraction than the material of the first rigid optical element 9 or the material of the second rigid optical element 11. Moreover, the optical element 8 comprises a third optical element 13, which is made of polymer. Furthermore, the optical component 8 comprises a flexible element 14, which is a membrane and is made of polymer and which is arranged between the second optical element 11 and the third optical element 13. The flexible element 14 and the third optical element 13 are embodied in a one-piece manner. The flexible element 13 and the third optical element 13 define a common surface 16, which is even according to FIG. 4, may however be curved. Alternatively, the first optical element 9 and second optical element 11 may be made of glass.

FIG. 5 shows a fourth embodiment of an optical component 8, which essentially comprises the same elements as the optical component 8 shown in FIG. 4. Therefore, the explanations with respect to FIG. 4 apply accordingly. In contrast to FIG. 4, however, the third optical element 13 as shown in FIG. 5 has a smaller extension along the optical axis 15. The embodiment according to FIG. 4 has a higher optical performance than the embodiment according to FIG. 5. The embodiment according to FIG. 5 is simpler and cheaper to manufacture than the embodiment according to FIG. 4.

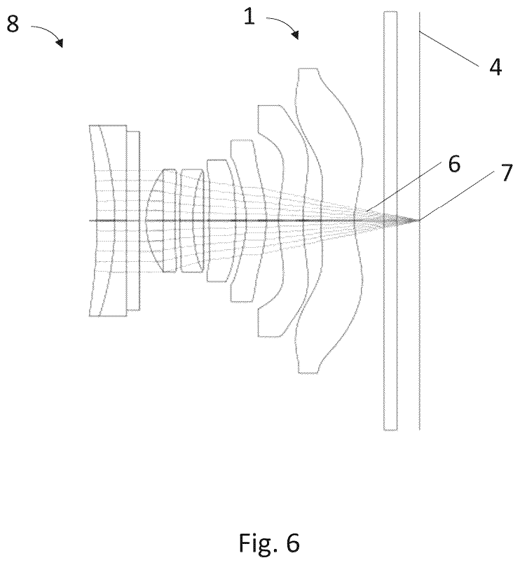

FIG. 6 shows the lens system 1 according to FIG. 1. For a better overview, only reference plane 4, the bundle of rays 6 and the focal point 7 are highlighted by their respective reference numerals. In contrast to FIG. 1, the lens system 1 is supplemented by an optical component 8 as shown in FIG. 3.

As a result of the use of the optical component 8, the arrangement shown in FIG. 3 has exceptionally stable optical properties which, in particular, do not vary significantly as a function of temperature. In contrast to the explanations regarding FIG. 1, studies have shown that the focal point 7 does not shift along the optical axis even with significant fluctuations in temperature.

The lens system 1 as shown in FIG. 6 is a possible embodiment of how the optical component 8 according to FIG. 3 can be used. It is of course also within the scope of the invention described here that an optical component 8 according to FIG. 2, 4 or 5 could be used instead and if required.

1. Optical component (8) having a temperature dependent focal length comprising:
a first rigid optical element (9) with a first interface (10);
a second rigid optical element (11) with a second interface (12);
a third optical element (13) comprising a third material, wherein the third optical element (13) is arranged between the first rigid optical element (9) and the second rigid optical element (11) such that the first interface (10) and the second interface (12) each face the third optical element (13);
the third optical element (13) having a larger temperature coefficient of index of refraction than first rigid optical element (9) or the second rigid optical element (11);
the first interface (10) and/or the second interface (12) being non-flat and configured to change an optical refraction power of the first interface (10) or to change an optical refraction power of the second interface (12) with changing temperature, wherein this change corresponds to the temperature dependent focal length of the optical component (8).

2. Optical component (8) according to claim 1, comprising a flexible element (14), which mechanically connects the first rigid optical element (9) with the second rigid optical element (11) and is configured to absorb a thermal expansion of the third optical element (13).

3. Optical component (8) according to one of the preceding claims, wherein the first interface is inflection point free in its optical area.

4. Optical component (8) according to one of the preceding claims, wherein an absolute value of the focal length change is larger than 1 diopter.

5. Optical component (8) according to one of the preceding claims, wherein a radius of the first interface or a radius of the second interface is smaller than 1 meter.

6. Optical component (8) at least according to claim 5, wherein the radius of the first interface or the radius of the second interface is smaller than 100 millimeters and preferably smaller than 10 millimeters.

7. Optical component (8) according to one of the preceding claims, wherein the third optical element is a fluid, a liquid or a gel.

8. Optical component (8) according to one of the preceding claims, wherein the third optical element is a polymer.

9. Optical component (8) at least according to claim 2, wherein the third optical element and the flexible element are embodied in a one-piece manner.

10. Optical component (8) according to one of the preceding claims, wherein the third optical element and the flexible element comprising a polymer or a gel.

11. Optical component (8) according to claim 7, wherein the fluid, a liquid or a gas, comprising of freely bounded molecules.

12. Optical component (8) according to one of the preceding claims, being designed as comprising a compensation value of more 10 milli diopters per Kelvin preferably more than 50 milli diopters per Kelvin.

13. Optical component (8) according to one of the preceding claims, wherein an absolute value of a refractive temperature index change of the fluid is at least 1*10\hat{ }-4 1/Kelvin, or at least 5*10\hat{ }-4 1/Kelvin or at least 8*10\hat{ }-4 1/Kelvin.

14. Optical component (8) according to one of the preceding claims, wherein a radius of the first interface comprises a midpoint, which is located in relation to the first rigid optical element towards the third optical element.

15. Optical component (8) according to one of the claims 1 to 13, wherein a radius of the first interface comprises a midpoint, which is located in relation to the first rigid optical element away from the third optical element.

16. Optical component (8) according to one of the preceding claims, wherein the first rigid optical element is designed as a lens.

17. Optical component (8) according to one of the preceding claims, wherein the first material comprises a polymer, plastic or a glass.

18. Optical component (8) according to one of the preceding claims, wherein the second optical element is designed as a window or a lens.

19. Optical component (8) according to one of the preceding claims, wherein the second material comprises a polymer, plastic or a glass.

20. Optical component (8) according to one of the preceding claims, wherein the flexible element is designed as a membrane, on which the second rigid optical element is attached.

21. Optical component (8) according to one of the preceding claims, wherein an optical power is substantially 0 diopter at room temperature.

22. Optical component (8) according to one of the preceding claims except claim 12, wherein, preferably at least at room temperature, a refractive index of the third optical element and a refractive index of the first or the second material are substantially the same, or the difference in said refractive indexes is smaller than 0.2 diopter or smaller than 0.5 diopter.

23. Optical component (8) at least according to claim 2, wherein the flexible element is designed as a membrane and is attached to the first interface and/or the second interface.

24. Optical component (8) according to one of the preceding claims, wherein a membrane is located between the third optical element, which in particular is a fluid, and the first or second rigid optical element.
